(19) United States
(12) Patent Application Publication
(10) Pub. No.: US 2007/0119861 A1
(43) Pub. Date: May 31, 2007

(54) Multichamber dispensing container

(76) Inventor: Abhay Arun Bhagwat, Mumbai (IN)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(21) Appl. No.: 10/560,624

(22) PCT Filed: Jan. 13, 2004
(86) PCT No.: PCT/EP04/00403

§ 371 Date: Jun. 8, 2006

(30) Foreign Application Priority Data
Jun. 12, 2003 (IN) 609/MUM/03

(51) Int. Cl. B65D 35/22; B67D 5/56

(52) U.S. Cl. 222/94; 222/129

(57) ABSTRACT

A multi-compartment dispenser comprising a deformable outer container body having a plurality of mutually separated compartments (A, B) for separately storing desired dissimilar materials which may have different viscosities, the compartments being separated by at least one elastic partition (3), with each compartment being provided with a discharge outlet (6, 7) adapted to provide a discharge aperture of an area proportional to the resistance to flow raised to an exponent whose value is greater than zero, said resistance to flow being of the material to be discharged from the respective compartments for controlled discharge of dissimilar materials from the discharge outlets.

The present invention relates to a multi-compartment dispenser for separate storage of dissimilar substances which are to be kept separate for one reason or another, e.g. because they are mutually chemically reactive and/or are physically dissimilar/incompatible, or because one wants to have perceptually attractive product forms with e.g. different colours. Also provided is controlled dispensing when combined use of such substances is required, by application of external pressure on the dispenser body which is deformable, but not collapsible in intended use.

While formulating a variety of products such as food/non-food products it is particularly desired to keep the chemically/physically incompatible materials stored separately until use. Cosmetic compositions for topical applications to skin or hair and for dental applications may be formulated as creams, pastes, lotions, gels etc. It is often desirable to keep parts of the formulation separate during storage for various obvious reasons, but it would be highly desirable to dispense them together at the time of use. Apart from chemical incompatibility that makes it essential to be stored separately, there are times when the physical, e.g. rheological properties of the components are different, and hence can not be formulated as a single composition.

To solve the problem different types of packaging have been designed and disclosed in the prior art. Most of them refer to tubes and not to moulded containers of e.g. the present invention, which may be rigid and made of plastics materials. (U.S. Pat. No. 5,860,565 (Enamelon, Inc. 1999), U.S. Pat. No. 5,076,464 (Patrick Simon, 1991), U.S. Pat. No. 5,269,441 (CP packaging, Inc., 1993).

IN183591 (Hindustan Lever, 1996), discloses an adaptor which enables two pre-made tubes such as toothpaste tubes of varying sizes to be fitted together, one inside the other, to obtain a dual tube dispenser providing for separate storage of two dissimilar substances, and its co-extrusion from said dispenser as and when desired upon application of external pressure on the latter.

In the above-mentioned prior art, one main drawback would be uncontrolled dispensing of the two separated material even though the rheologies of the material may be similar.

The conventional solution to control dispensing of rheologically different materials is to provide a volumetric mechanical pump on the multiple compartments of the pack. However, this is significantly expensive and entails the use of large quantities of plastic.

EP918698 (Colgate-Palmolive, 2001), discloses a method whereby it is possible in multi compartment collapsible tubes to uniformly co-dispense physically segregated dentifrice compositions. The method involves moving of the partition in response to a pressure difference developed due to the applied pressure during dispensing. This application is restricted to collapsible tubes and for dentifrice compositions.

U.S. Pat. No. 5,921,440, (Maines, 1999) discloses a multi-compartment container where the bottles are designed to dispense contents from one or both the compartments.

It would be apparent from the above state of the art that while multi-component dispensers are known to store and dispense simultaneously chemically and/or physically dissimilar materials, none of the known art dispensers achieve a simple and cost-effective solution to the required controlled dispensing of rheologically different materials stored in separate containers such as materials with widely different viscosities. It is important to note that when the materials are of substantially different viscosity simple partition and/or collapsible outer body is not sufficient to ensure desired controlled dispensing of the dissimilarly viscous materials.

Thus, while containers/closures are known to store different materials and simultaneously dispense the same considering that such materials are also very often necessarily dissimilar in rheology such as e.g. having a difference in viscosity, it is extremely difficult to ensure simultaneous dispensing and at the same time effectively control the flow rate of such dissimilar materials during dispensing. Moreover, mostly the related art in the field is limited to collapsible tubular containers used for simultaneous dispensing of dissimilar materials which cannot be extended for moulded deformable polymeric containers which due to its moulded body have different deformation characteristics vis-à-vis collapsible tubular packs. For the said reason it is all the more difficult to achieve co-dispensing of controlled amounts of two or more physically dissimilar substances/compositions from multi-compartment moulded deformable polymeric containers.

It is thus the basic object of the present invention to provide multi-compartment moulded, polymeric containers for storing and uniformly codispensing a variety of two or more physically/rheologically different materials which would be cost-effective, simple, reliable and easy to operate.

Another object is directed to provide multi-compartment polymeric moulded containers for storing and uniformly dispensing in controlled proportions a range of materials irrespective of the differences between them, such as differences in viscosity and the like, by way of a simple and cost-effective control on the discharge of respective contents of the respective compartments of containers. This would involve a selective transmittable deformable form of the outer container body and the separating layers of the containers for separate storage of the dissimilar materials and the outlet/apertures of the respective compartments based on the different physical/rheological properties of the materials to be stored and dispensed.

Another object of the present invention is directed to provide for multi-compartment moulded polymeric containers for storing separately and uniformly codispensing substances that are chemically and/or physically dissimilar, thus ensuring controlled and substantially uniform usage of the two or more compositions, and thus ensuring consumer need and reducing wastage of any of the compositions that may be left over in excess due to non-regulated dispensing.

Yet another object of the present invention is directed to provide for hand-held multi-compartment moulded polymeric containers for storing separately and uniformly codispensing substances that are chemically and/or physically dissimilar/incompatible, the compartment adapted to contain cosmetic/food compositions and the like which can be safely handled by children and even aged people without exposing dangers of injury to the user and/or damage to the packaging.

Yet further object of the present invention is directed to provide for multi-compartment moulded polymeric containers for storing separately and uniformly codispensing materials that are chemically and/or physically dissimilar or incompatible, which would be attractive and have an aesthetic get up, and also importantly avoid the need to separately dispense the materials that are essentially required to be used together for best results and are more conveniently co-dispensed, rather than sequentially dispensed.

According to a first aspect of the present invention there is provided a multi-compartment dispenser comprising:
i) deformable outer container body with a plurality of mutually separated compartments inside for separately storing desired dissimilar materials;
ii) the said compartments separated by elastic partition(s);
iii) each said compartment provided with a discharge outlet means adapted to provide a discharge aperture of an area proportional to the ‘resistance to flow’ raised to an exponent whose value is greater than zero, said ‘resistance to flow’ being of the material to be discharged from the respective compartments for controlled discharge of dissimilar materials from said discharge outlets.

In accordance with one aspect of the present invention, in the multi-compartment dispenser each of said plurality of compartments may comprise an outer deformable moulded body portion and internal elastic partitioning member with the adjacently facing members of the respective compartments sealed together with the partition to effectively transmit the deforming pressure on the container body, the said outer deformable body portions of the adjacent compartments being sealed together to together define said deformable container outer body.

In accordance with another aspect of the present invention, the multi-compartment dispenser comprises a common outer deformable container body with plurality of elastic partitions members inside, with the adjacently facing partition members sealed together to internally define said plurality of compartments and to effectively transmit the deforming pressure on the container body to the various compartments required for regulated dispensing of the contents from the respective compartments. In some embodiments, the container may only one elastic partition member separating the compartments.

According to a preferred aspect of the present invention there is provided a multi-compartment dispenser comprising:
i. deformable outer container body that is not collapsible during use, with a plurality of mutually separated compartments inside for separately storing desired dissimilar materials;
ii. the said compartments formed by elastic partition(s), the area of the said partition(s) being selected to be equal to or greater than the cross sectional area of the container along the partition;
iii. each said compartment provided with a discharge outlet means adapted to provide a discharge aperture of an area proportional to the ‘resistance to flow’ raised to an exponent whose value is between 0.1 to 5, said ‘resistance to flow’ being of the material to be discharged from the respective compartments for controlled discharge of dissimilar materials from said discharge outlet.

According to a more preferred feature of the invention there is provided a multi-compartment dispenser comprising:
i. deformable outer container body that is not collapsible during use, with a plurality of mutually separated compartments inside for separately storing desired dissimilar materials;
ii. the said compartments formed by elastic partition/s; the said partition/s being corrugated;
iii. each said compartment provided with a discharge outlet means adapted to provide a discharge aperture of an area proportional to the ‘resistance to flow’ raised to an exponent whose value is between 0.1 to 5, said ‘resistance to flow’ being of the material to be discharged from the respective compartments for controlled discharge of dissimilar materials from said discharge outlet.

It is particularly preferred that the discharge outlet for each said compartment is adapted to provide an aperture of an area proportional to the ‘resistance to flow’ raised to an exponent whose value is between 0.1 to 5, said ‘resistance to flow’ being of the material to be discharged and is directly proportional to the ratio in which the material is required to be discharged with respect to materials in the other compartments of the container on application of the discharging force on the outer body.

The essential features of the present invention relating to a multi-compartment, deformable polymeric moulded container capable of uniform co-dispensing of spatially separated products from the container relate to the combination of the elasticity of the partition members in the container forming the compartments, and the compartment outlet means adapted to provide the selective discharge aperture in relation to the physical properties of the compositions stored and the ratio in which they have to be discharged. In particular, the containers may act so as to have active pressure equalization via the flexible membranes partition(s).

The walls of the deformable container body are formed by any known polymeric material, and may be preferably chosen from relatively rigid, plastics materials such as polyolefins, e.g. High Density Polyethylene (HDPE), Low Density Polyethylene (LDPE/LLDPE), Polypropylene (PP), ethylene and propylene copolymers or from polyesters e.g. Polyethylene Terephthalate (PET) or Polyvinyl Chloride (PVC). The thickness of the materials preferably does not exceed 5 milimeters and more preferably does not exceed 1 mm.

The said compartments are separated by elastic partition members with the elasticity and/or area and/or construction of the elastic partition members selected based on the disposition of the partition member in relation to the outer body and/or the rheology of the contents to be stored.

The partitions used to separate the compartments in the container may also be made from any known polymeric materials. When the partition is corrugated, it is preferably made from materials chosen from thermoplastics such as polyolefins or from elastomers such as rubbers. When the partition is uncorrugated, it is preferably made from elastomers such as rubbers with a tensile strength of less than 10 kg/mm², an elongation of less than 1000% and a thickness preferably less than about 2 mm. The partition/s are substantially inert and non-permeable to the ingredients of the formulation.

The respective compartment outlets are preferably adapted to provide a discharge aperture whose area is:
a) Proportional to the ‘resistance to flow’ raised to an exponent whose value is between 0.1 to 5, said ‘resistance to flow’ being offered by the composition in the above compartment, and is
b) Directly proportional to the ratio in which the composition is required to be co-dispensed with other compositions.

It is possible by way of the above combination of the selective elastic partition and the discharged outlet for the plurality of respective compartments to provide for a uniform/controlled discharge of materials of a wide variety such as materials with substantially different viscosities in moulded polymeric dispensers.

In accordance with one aspect the process for forming the container of the invention comprises providing a plurality of shells having a moulded deformable outer body and inner elastic partition which may be assembled to form the container. The shells are obtained of moulding, wherein plastic granules are molten and filled into a die under pressure, (with or without a stage of intermediate tubular pre-form) then cooled and removed from the die.

The shells assemble into a container in the shape of a closed three-dimensional hollow object, except for any openings provided by design for filling and fitting other components such as valves. It is fitted with suitable valve(s) and cap(s), prior to which it is filled with fluid formulation components from the opening(s) mentioned herein. It is then suitably decorated and provided with readable textual matter.

When the above processes are complete, the container hereinafter referred to as ‘the package’, can be used by the consumer for storing and uniformly co-dispensing the multiple formulation components in appropriate dosages for food or non-food applications. Before or after use, it may be able to rest on one or more of its surfaces and may be described as a multi-compartment bottle. It may be able to rest on the cap so as to appear like an upside-down bottle, also known as ‘Tottle’ in some areas of the trade. It may also be provided with a feature such as a hook so that it may be suitably hung on a wall or freely in a vertical configuration from a suitable fixture.

The net total volume of the contents of the container can typically be between 1 ml and 1000 ml.

The details of the invention its objects and advantages are explained hereunder in greater detail in relation to non-limiting exemplary embodiments of the multi-compartment container in accordance with the present invention as per the accompanying figures, wherein:

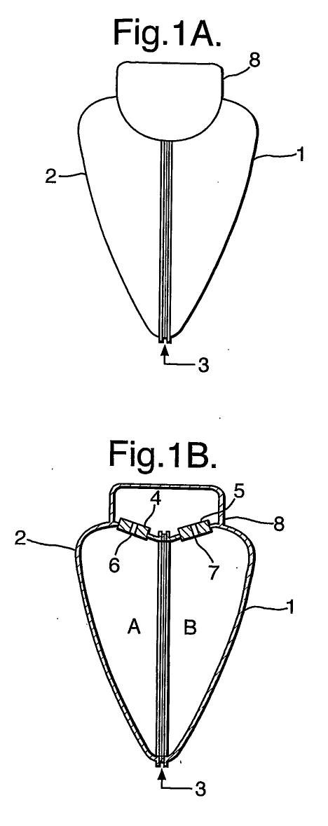

FIG. 1A is a front view of an embodiment of the container of the invention with outlet closed; and

FIG. 1B illustrates a front sectional view of an embodiment of the container in accordance with the present invention.

As shown in said FIGS. 1A and 1B, the container comprise of moulded polymeric shells (1,2) having integral peripheral rims with flat sealing surfaces. The elastic partition member (3) is securely held between the rims of the two shells which are sealed together to form the compartments A and B. Formulation components are filled through the holes in the shells and valves 4 and 5 having the apertures 4A and 5A, are fitted in the holes. A cap (6) is fitted so as to cover the apertures.

The elastic partition member, its material, area, construction and disposition along with the outlet valves are preferably selected based on the rheology and the desired flow control from the respective compartments. This provides for the required simultaneous flow and required control of the rate of flow from the multi-compartment dispenser of the invention, and avoids the problem of achieving controlled simultaneous flow even in case of material of dissimilar rheology for multi-compartment dispensers including that for moulded multi-compartment dispensers.

1. A multi-compartment dispenser comprising a deformable outer container body having a plurality of mutually separated compartments for separately storing desired dissimilar materials which may have different viscosities, the compartments being separated by at least one elastic partition, with each compartment being provided with a discharge outlet adapted to provide a discharge aperture of an area proportional to the resistance to flow raised to an exponent whose value is greater than zero, said resistance to flow being of the material to be discharged from the respective compartments for controlled discharge of dissimilar materials from the discharge outlets.

2. The multi-compartment dispenser of claim 1 wherein the area of the discharge aperture of each compartment is directly proportional to the ratio in which the material is required to be discharged with respect to the materials contained in the other compartments.

3. The multi-compartment dispenser of claim 1 wherein adjacently facing members of the respective compartments are sealed together with the partition, and the outer deformable body portions of the adjacent compartments are sealed together to define the deformable container outer body.

4. The multi-compartment dispenser of claim 1 wherein the area of the at least one partition is equal to or greater than the cross sectional area of the container along the partition.

5. The multi-compartment dispenser of claim 1 wherein the at least one partition is corrugated.

6. The multi-compartment dispenser of claim 1 wherein there are a plurality of elastic partitions.

7. The multi-compartment dispenser of claim 1 wherein the deformable outer container body is not collapsible.

8. The multi-compartment dispenser of claim 1 wherein the dispenser is hand-held.

9. The multi-compartment dispenser of claim 1 wherein the exponent has a value between 0.1 and 5.
